(19) United States
(12) Patent Application Publication
(10) Pub. No.: US 2020/0332856 A1
(43) Pub. Date: Oct. 22, 2020

(54) BALANCER APPARATUS

(71) Applicant: HITACHI AUTOMOTIVE SYSTEMS, LTD., Hitachinaka-shi, Ibaraki (JP)

(72) Inventor: Masahumi KURITA, Zama-shi, Kanagawa (JP)

(73) Assignee: HITACHI AUTOMOTIVE SYSTEMS, LTD., Hitachinaka-shi, Ibaraki (JP)

(21) Appl. No.: 15/998,961

(22) PCT Filed: Feb. 14, 2017
(86) PCT No.: PCT/JP2017/005368

§ 371 Date: Aug. 17, 2018

(30) Foreign Application Priority Data
Feb. 19, 2016 (JP) 2016-029431

(51) Int. Cl. F16F 15/26; F01M 1/02

(52) U.S. Cl. CPC F16F 15/264; F01M 2001/0276; F01M 1/02

(57) ABSTRACT

An object of the present invention is to improve design flexibility of a balancer apparatus. A balancer apparatus includes a balancer shaft, a balancer housing, and an oil pump including an oil pump housing formed separately from the balancer housing and attached to the balancer housing. The balancer housing includes an upper housing and a lower housing formed separately from the upper housing. The lower housing includes first to third bosses configured to fasten the oil pump to the lower housing. The first and second bosses protrude downward on one end side of an axial direction of the balancer shaft. The third boss is disposed on an upper side with respect to the first and second bosses. The first and second bosses are disposed so as to be spaced apart from each other in a direction orthogonal to the axial direction in such a manner that a recessed portion is formed therebetween. The oil pump includes an intake portion having an opening portion. The intake portion is disposed at least partially in the recessed portion.

### TECHNICAL FIELD

The present invention relates to a balancer apparatus.

### BACKGROUND ART

PTL 1 discloses a balancer apparatus coupled with an oil pump. In this balancer apparatus, an oil pump housing containing an oil pump mechanism therein, and a balancer housing containing a balancer shaft therein are formed integrally with each other.

### CITATION LIST

### Patent Literature

[PTL 1] Japanese Patent No. 3668548

### SUMMARY OF INVENTION

### Technical Problem

However, forming the oil pump housing and the balancer housing integrally with each other leads to low design flexibility.

### Solution to Problem

According to a first aspect of the present invention, a balancer apparatus is provided. This balancer apparatus includes a balancer shaft configured to be rotationally driven, a balancer housing rotatably containing the balancer shaft therein, and an oil pump including an oil pump housing formed separately from the balancer housing and attached to the balancer housing. The balancer housing includes an upper housing and a lower housing formed separately from the upper housing. The lower housing includes a first boss and a second boss configured to fasten the oil pump to the lower housing and protruding downward on one end side of an axial direction of the balancer shaft, and a third boss configured to fasten the oil pump to the lower housing and disposed on an upper side with respect to the first boss and the second boss. The first boss and the second boss are disposed so as to be spaced apart from each other in a direction orthogonal to the axial direction in such a manner that a recessed portion is formed therebetween. The oil pump includes an intake portion having an opening portion for introducing oil into the oil pump. The intake portion is disposed at least partially in the recessed portion.

According to the above-described balancer apparatus, the balancer housing and the oil pump housing are different members. Therefore, the balancer apparatus can be designed highly flexibly. Further, the first boss and the second boss protrude downward, so that the first to third bosses can be arranged in a wide width in a vertical direction. In other words, the oil pump can be supported over a further wide range. Therefore, the oil pump can be supported with improved stiffness. In addition, the intake portion of the oil pump is disposed at least partially in the recessed portion formed between the first boss and the second boss, which contributes to preventing or cutting down an increase in a height of the balancer apparatus due to the downward protrusion of the first boss and the second boss.

According to a second aspect of the present invention, in the first aspect, the lower housing includes a fourth boss configured to fasten the oil pump to the lower housing and disposed on the upper side with respect to the first boss and the second boss. According to this aspect, the oil pump can be supported at at least four points, and therefore can be supported with improved stiffness.

According to a third aspect of the present invention, in the first or second aspect, the first boss includes a first screw hole on a distal end side thereof. The second boss includes a second screw hole on a distal end side thereof. Half or more of the intake portion is disposed on an upper side with respect to an imaginary line connecting a center of the first screw hole and a center of the second screw hole in a cross section orthogonal to the axial direction. According to this aspect, the increase in the height of the balancer apparatus can be effectively prevented or cut down.

According to a fourth aspect of the present invention, in any of the first to third aspects, the opening portion is opened toward an opposite end side in the axial direction. According to this aspect, the increase in the height of the balancer apparatus can be prevented or cut down.

According to a fifth aspect of the present invention, in the fourth aspect, the balancer apparatus further includes a strainer extending in the axial direction and including a first end portion connected to the opening portion and a second end portion opened downward. According to this aspect, while the increase in the height of the balancer apparatus is prevented or cut down, the oil can be introduced from a desired position in an oil pan covering a lower side of the balancer apparatus.

According to a sixth aspect of the present invention, in any of the first to third aspects, the opening portion is opened downward. According to this aspect, the increase in the height of the balancer apparatus can be prevented or cut down.

According to a seventh aspect of the present invention, in the seventh aspect, the intake portion includes a strainer portion extending from the opening portion downward. The strainer portion is formed integrally with the intake portion. According to this aspect, the number of components can be reduced. Further, the strainer portion allows the oil to be easily introduced.

According to an eighth aspect of the present invention, in the second aspect or any of the third to seventh aspects including the second aspect, at least one of the third boss and the fourth boss is formed so as to protrude upward beyond mating surfaces between the upper housing and the lower housing. According to this aspect, the first to fourth bosses can be arranged over a further wide width in the vertical direction without being accompanied by an increase in the height of the balancer apparatus. Therefore, the oil pump can be supported with further improved stiffness.

According to a ninth aspect of the present invention, in the second aspect, any of the third to seventh aspects including the second aspect, or the eighth aspect, at least one of the first to fourth bosses is reinforced by a reinforcement rib extending from the lower housing. According to this aspect, the oil pump can be supported with further improved stiffness.

According to a tenth aspect of the present invention, in the ninth aspect, the lower housing includes a bearing support portion partially containing therein a bearing configured to rotatably support the balancer shaft. The reinforcement rib is connected to the bearing support portion. The bearing support portion is normally formed so as to have higher stiffness than other portions of the housing, so that, according to this aspect, the oil pump can be supported with further improved stiffness.

According to an eleventh aspect of the present invention, in the tenth aspect, the reinforcement rib connects at least one of the first boss and the second boss and at least one of the third boss and the fourth boss, and the bearing support portion to each other. According to this aspect, the oil pump can be supported with further improved stiffness.

According to a twelfth aspect of the present invention, in any of the first to eleventh aspects, the balancer shaft includes a drive shaft to which a rotational force of a crankshaft of an engine is transmitted, and a driven shaft configured to rotate in an opposite direction from the drive shaft by a rotational force transmitted from the drive shaft. The rotational force is transmitted to the oil pump by the drive shaft or the driven shaft. According to this aspect, the balancer apparatus can have a compact size.

According to a thirteenth aspect of the present invention, a balancer apparatus is provided. This balancer apparatus includes a balancer shaft configured to be rotationally driven, a balancer housing rotatably containing the balancer shaft therein and including a first balancer housing and a second balancer housing formed separately from the first balancer housing and coupled with the first balancer housing, and an oil pump including an oil pump housing formed separately from the balancer housing and attached to the first balancer housing. The balancer housing includes a first boss and a second boss configured to fasten the oil pump to the first balancer housing and protruding downward on one end side of an axial direction of the balancer shaft, and a third boss configured to fasten the oil pump to the lower housing and disposed on an upper side with respect to the first boss and the second boss. The first boss and the second boss are disposed so as to be spaced apart from each other in a direction orthogonal to the axial direction in such a manner that a recessed portion is formed therebetween. The oil pump includes an intake portion having an opening portion for introducing oil into the oil pump. The intake portion is disposed at least partially in the recessed portion. According to this balancer apparatus, similar effect to the first aspect are brought about. Any of the third to eleventh aspects can also be applied to the twelfth aspect.

According to a fourteenth aspect of the present invention, in the thirteenth aspect, the first boss includes a first screw hole on a distal end side thereof. The second boss includes a second screw hole on a distal end side thereof. Half or more of the intake portion is disposed on an upper side with respect to an imaginary line connecting a center of the first screw hole and a center of the second screw hole in a cross section orthogonal to the axial direction. According to this aspect, a similar effect to the second aspect is brought about.

According to a fifteenth aspect of the present invention, in any of the first to fourteenth aspects, the balancer apparatus includes a speed reduction mechanism. The oil pump is a variable displacement oil pump capable of varying a discharge volume thereof. A rotational force of the balancer shaft is transmitted to the oil pump via the speed reduction mechanism.

According to a sixteenth aspect of the present invention, in the fifteenth aspect, the balancer shaft includes a drive shaft to which a rotational force of a crankshaft of an engine is transmitted, and a driven shaft configured to rotate in an opposite direction from the drive shaft by a rotational force transmitted from the drive shaft. The speed reduction mechanism includes a drive gear and a driven gear having a larger number of teeth than the drive gear. The drive gear is fixed to the driven shaft. The driven gear is fixed to a drive shaft of the oil pump. According to this aspect, the oil pump can be driven at a relatively low speed, so that pump efficiency is improved, as a result of which fuel efficiency is improved.

According to a seventeenth aspect of the present invention, in the sixteenth aspect, the recessed portion is disposed right below the driven shaft. A shaft center of the driven shaft is disposed on an upper side with respect to a shaft center of the driven gear. According to this aspect, a depth of the recessed portion can be increased by an amount corresponding to the upward offset of the shaft center of the driven shaft from the shaft center of the driven gear. In other words, the depth of the recessed portion containing the intake portion therein is increased, so that the intake portion can be contained further deeply in the recessed portion. Therefore, the increase in the height of the balancer apparatus can be further prevented or cut down. Any of the fourteenth to sixteenth aspects can also be applied to any of the first to eleventh aspects.

### BRIEF DESCRIPTION OF DRAWINGS

FIG. 1 is a perspective view of a balancer apparatus according to a first embodiment.

FIG. 2 is a bottom view of the balancer apparatus according to the first embodiment.

FIG. 3 is a right side view of the balancer apparatus according to the first embodiment.

FIG. 4 is a front view of the balancer apparatus according to the first embodiment.

FIG. 5 is a rear view of the balancer apparatus according to the first embodiment.

FIG. 6 is a cross-sectional view of the balancer apparatus taken along a line S6-S6 illustrated in FIG. 3.

FIG. 7 is a perspective view of a balancer apparatus according to a second embodiment.

FIG. 8 is a perspective view of the balancer apparatus according to the second embodiment, and illustrates the balancer apparatus with an oil pump removed therefrom.

FIG. 9 is a bottom view of the balancer apparatus according to the second embodiment.

FIG. 10 is a bottom view of the balancer apparatus according to the second embodiment, and illustrates the balancer apparatus with the oil pump removed therefrom.

FIG. 11 is a perspective view of the balancer apparatus according to the second embodiment from which the oil pump is removed.

FIG. 12 is a cross-sectional view of the balancer apparatus according to the second embodiment that corresponds to FIG. 6.

### DESCRIPTION OF EMBODIMENTS

### First Embodiment

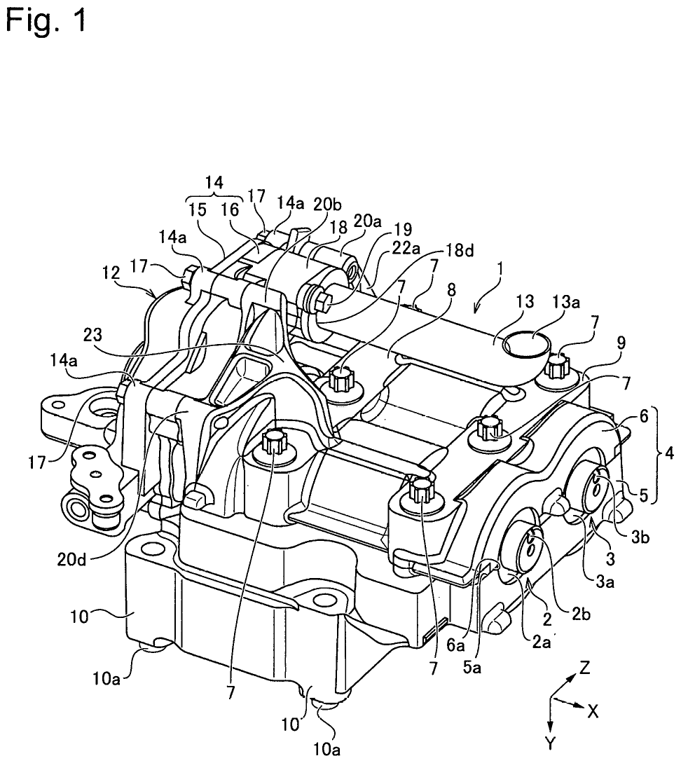

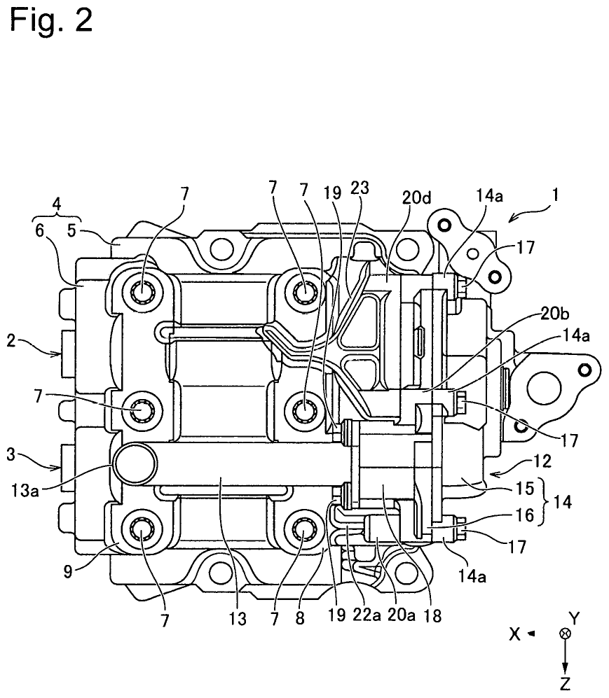

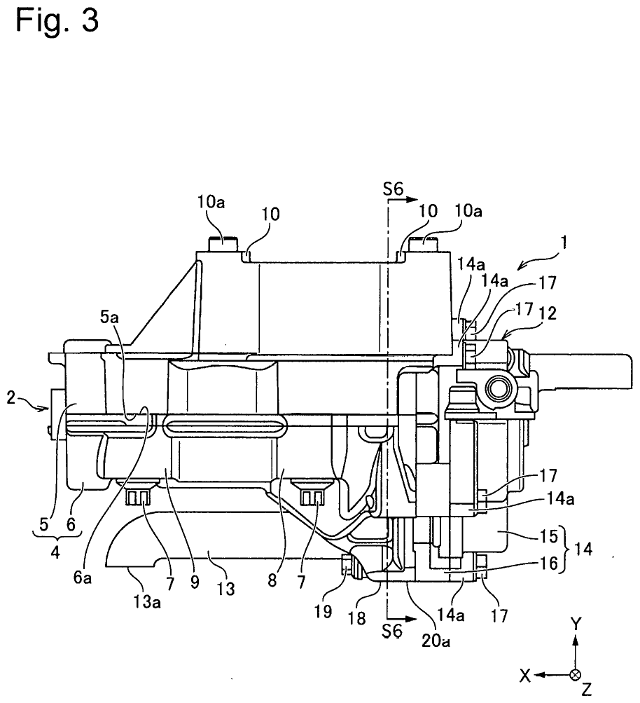

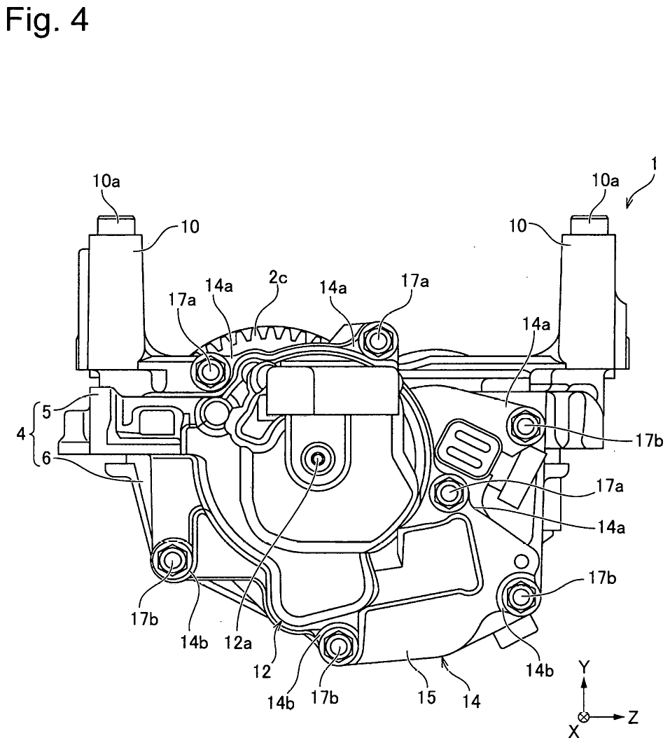

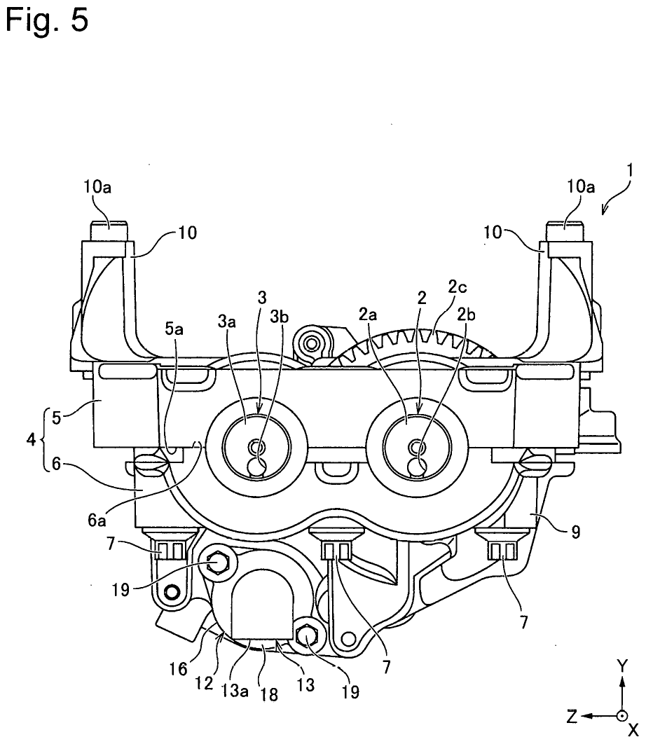

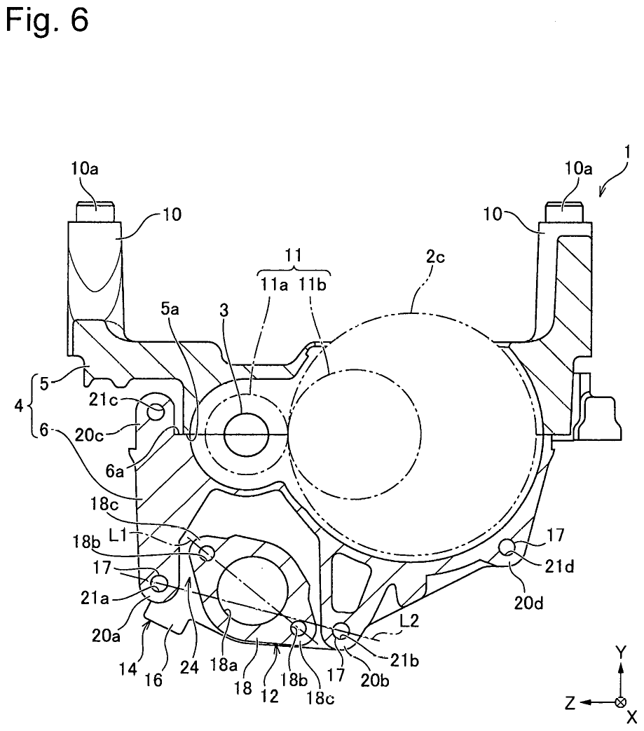

A first embodiment of the present invention will be described. FIG. 1 is a perspective view of a balancer apparatus 1 according to the first embodiment. FIG. 2 is a bottom view of the balancer apparatus 1. FIG. 3 is a right side view of the balancer apparatus 1. FIG. 4 is a front view of the balancer apparatus 1. FIG. 5 is a rear view of the balancer apparatus 1. FIG. 6 is a cross-sectional view taken along a line S6-S6 illustrated in FIG. 3. In the present disclosure, an “upper side” is defined to be a vertically upper side in a state where the balancer apparatus 1 is mounted on a vehicle (a vehicle mounted state), and a “lower side” is defined to be a vertically lower side in the vehicle mounted state.

The balancer apparatus 1 is contained in an oil pan (not illustrated) attached to a lower portion of a cylinder block (not illustrated) of an engine. The engine is, for example, an in-line four-cylinder reciprocating engine. As illustrated in FIG. 1, the balancer apparatus 1 includes balancer shafts 2 and 3 and a balancer housing 4. The balancer shaft 2 will also be referred to as a drive shaft 2, and the balancer shaft 3 will also be referred to as a driven shaft 3. The drive shaft 2 and the driven shaft 3 are contained inside the balancer housing 4. The balancer shafts 2 and 3 are disposed in such a manner that longitudinal directions (rotational axis directions) thereof extend in parallel with each other along a front-rear direction of the engine and are arranged generally symmetrically in the same horizontal plane with respect to a vertical surface passing through a rotational axis of a crankshaft (not illustrated) in the vehicle mounted state.

In the following description, an X axis, a Y axis, and a Z axis are set to the front-rear direction, a vertical direction, and a left-right direction of the engine, respectively. Further, the present embodiment will be described, assuming that an X-axis positive direction, a Y-axis positive direction, and a Z-axis positive direction are a direction extending from a front side to a rear side of the engine, a direction extending from a lower side to an upper side of the engine (a vertically upward direction), and a direction extending from a right side to a left side as viewed from the front side of the engine, respectively.

The balancer shafts 2 and 3 each include an axis (a rotational axis) extending in the X-axis direction. The balancer shafts 2 and 3 each include a generally semi-cylindrical balancer weight (not illustrated) having a center of gravity offset from the axis of the balancer shaft 2 or 3 as viewed in the X-axis direction. Both the balancer weights are constantly located at the same heights as each other during rotations of the balancer shafts 2 and 3. A pair of interlocking gears 2a and 3a meshed with each other is provided at ends of the balancer shafts 2 and 3 in the X-axis positive direction, respectively. Further, reference holes 2b and 3b are formed at the ends of the balancer shafts 2 and 3 in the X-axis positive direction, respectively. A positioning clip (not illustrated) is mounted in each of the reference holes 2b and 3b when the balancer apparatus 1 is attached to the cylinder block. A driven gear 2c meshed with a drive gear (not illustrated) fixed to the crankshaft is fixed at around an end of the drive shaft 2 in the X-axis negative direction (refer to FIG. 4). Due to this configuration, the balancer shafts 2 and 3 rotate in synchronization with the crankshaft. In the present embodiment, a speed ratio between the drive gear and the driven gear 2c is 2, and the balancer shafts 2 and 3 rotate at a speed twice the crankshaft.

The balancer housing 4 includes an upper housing 5 and a lower housing 6 formed separately from the upper housing 5. The upper housing 5 and the lower housing 6 (hereinafter also referred to as balancer housings 5 and 6) are formed so as to have generally half-divided shapes divided vertically into two members, and are in abutment with each other by mating surfaces 5a and 6a extending in parallel with the X axis. The balancer housings 5 and 6 are fastened in the Y-axis direction with use of six housing fastening bolts 7.

Bearings (not illustrated), which rotatably support the balancer shaft 2 or 3, are provided on both sides of a weight containing portion (not illustrated) in the X-axis direction inside the balancer housings 5 and 6. The weight containing portion contains therein each of the balancer weights of the balancer shafts 2 and 3. Bearing support portions 8 and 9, which contain these bearings, are formed on the lower housing 6. The bearing support portions 8 and 9 are formed with a great thickness compared to other portions of the lower housing 6, thereby having high stiffness. The bearing support portion 8 is positioned on an X-axis negative direction side of the balancer weight, and the bearing support portion 9 is positioned on an X-axis positive direction side of the balancer weight. A bottom surface (a surface on a Y-axis negative direction side) of each of the bearing support portions 8 and 9 has a predetermined width in the X-axis direction and extends in the Z-axis direction. Three of the six housing fastening bolts 7 are disposed outside the balancer shafts 2 and 3 and between the balancer shafts 2 and 3, and are lined up in the Z-axis direction, at the bearing support portion 8. The remaining three bolts 7 are disposed outside the balancer shafts 2 and 3 and between the balancer shafts 2 and 3, and are lined up in the Z-axis direction, at the bearing support portion 9.

Four leg portions 10 extending in the Y-axis positive direction are provided at four corners of the upper housing 5 in the X-axis direction and the Z-axis direction. A positioning hollow pin 10a protrudes upward at an end of each of the leg portions 10 in the Y-axis positive direction. The positioning hollow pin 10a is press-fitted in the leg portion 10. A balancer fastening bolt (not illustrated) is inserted in each of the leg portions 10 and the positioning hollow pin 10a. The balancer fastening bolt is used to fasten the balancer housing 4 to the cylinder block from the Y-axis negative direction side.

An oil pump 12 is coupled with an end of the driven shaft 3 in the X-axis negative direction via a speed reduction mechanism 11 as illustrated in FIG. 6. The speed reduction mechanism 11 includes a drive gear 11a and a driven gear 11b. The drive gear 11a is fixed to the end of the driven shaft 3 in the X-axis negative direction. The driven gear 11b is fixed to a drive shaft 12a (refer to FIG. 4) of the oil pump 12. Due to this configuration, the oil pump 12 is rotationally driven in synchronization with the balancer shafts 2 and 3. The driven gear 11b has a larger number of teeth than the drive gear 11a, and a speed ratio between the drive gear 11a and the driven gear 11b is 1/2. Therefore, the oil pump 12 rotates at a speed half the balancer shafts 2 and 3. A rotational center of the drive shaft of the oil pump 12 is located on a Z-axis positive direction side and the Y-axis negative direction side with respect to a rotational center of the driven shaft 3.

The oil pump 12 pressurizes oil introduced from an oil strainer 13 and discharges this oil to a main oil gallery (not illustrated). The oil discharged to the main oil gallery is transmitted mainly to each sliding portion of the engine and provided for lubrication. Further, a part of the oil is provided for lubrication of the balancer shafts 2 and 3. In the present embodiment, the oil pump 12 is a variable displacement oil pump capable of varying an amount of a change in a volume of a pump chamber (i.e., a discharge volume). The variable displacement oil pump is a vane pump having a mechanism that reduces the amount of the change in the volume of the pump chamber at the time of a high rotation of the pump. Any known pump (for example, a pump disclosed in Japanese Patent Application Public Disclosure No. 2011-111926) can be used as the variable displacement oil pump.

The oil pump 12 includes an oil pump housing 14. The oil pump housing 14 includes a pump body 15 and a pump cover 16. The pump body 15 and the pump cove 16 are in abutment with each other on mating surfaces thereof extending in parallel with a YZ plane. The pump housing 14 and the pump body 15 are assembled with use of three pump assembling bolts 17a. The oil pump 12 and the balancer housing 4 are fastened together from the X-axis negative direction side with use of four pump fastening bolts 17b. As illustrated in FIG. 4, each of the pump fastening bolts 17a and 17b is disposed along an outer periphery of the oil pump housing 14 as viewed in the X-axis direction. A plurality of bosses 14a and 14b is formed on the outer periphery of the oil pump housing 14. Each of the plurality of bosses 14a includes a screw hole, and each of the pump assembling bolts 17a is inserted in this screw hole. Further, each of the plurality of bosses 14b includes a screw hole, and each of the pump assembling bolts 17b is inserted in this screw hole.

The pump cover 16 includes an intake portion 18 at an end thereof in the Y-axis negative direction. The intake portion 18 includes an opening portion 18d for introducing the oil into the oil pump 12. The opening portion 18d is opened toward the X-axis positive direction. One end of the oil strainer 13 is connected to this opening portion 18d. The oil strainer 13 extends to the bearing support portion 9 in the X-axis positive direction. The other end (a distal end portion 13a) of the oil strainer 13 is curved at 90 degrees toward the Y-axis negative direction side at the bearing support portion 9, and is opened downward (in the Y-axis negative direction). The intake portion 18 and the oil strainer 13 are disposed between the adjacent housing fastening bolts 7 in the Z-axis direction. Therefore, the oil strainer 13 and the housing fastening bolts 7 are prevented from interfering with each other in the Y-axis direction. Therefore, the oil strainer 13 can be disposed on the Y-axis positive direction side with respect to head portions of the housing fastening bolts 7. As a result, a dimension of the balancer apparatus 1 in the Y-axis direction can be reduced, and the apparatus can have a compact size. Further, according to the balancer apparatus 1, the intake portion 18 is disposed at generally the same position as the driven shaft 3 in the Z-axis direction. In other words, the intake portion 18 is not disposed on one side where the drive shaft 2 is located but is located on the other side where the driven shaft 3 is located. Therefore, the intake portion 18 is prevented from interfering with a driven gear chamber containing the driven gear 2c therein unlike when the intake portion 18 is disposed on the one side where the drive shaft 2 is located. Therefore, the intake portion 18 can be disposed in such a manner that the intake portion 18 and the driven gear chamber partially overlap each other in the Y-axis direction. As a result, since the intake portion 18 and the driven gear chamber can be disposed so as to overlap each other, the dimension of the balancer apparatus 1 in the Y-axis direction can be reduced and the apparatus can have a compact size. Further, the intake portion 18 and the oil strainer 13 are provided so as to be entirely contained in an area over which the oil pump housing 14 is projected as viewed in the X-axis direction. Therefore, the balancer apparatus 1 can have a compact size. As illustrated in FIG. 6, two bosses 18c having screw holes 18b are provided at a distal end of the intake portion 18. By inserting strainer fastening bolts 19 into these screw holes 18b from the X-axis positive direction side, the oil strainer 13 is fastened to the intake portion 18. An imaginary line L1 connecting centers of the two screw holes 18b is provided obliquely with respect to a surface of each of the bearing support portions 8 and 9 of the balancer housing 4, i.e., an XZ plane. Therefore, a dimension of the intake portion 18 in the Z-axis direction can be reduced, and the apparatus can have a compact size.

An intake passage 18a extending in the X-axis direction is formed inside the intake portion 18. The intake passage 18a is in communication with a pump chamber (not illustrated) of the oil pump 12 on one end side thereof and with the oil strainer 13 on the other end side thereof. Due to this configuration, when the oil pump 12 is driven, the oil introduced from the oil pan into the oil strainer 13 is supplied into the pump chamber via the intake passage 18a.

As illustrated in FIG. 6, the lower housing 6 includes a first boss 20a and a second boss 20b at an end thereof in the X-axis negative direction. Both the first boss 20a and the second boss 20b protrude downward. The first boss 20a and the second boss 20b protrude by a height set within such a range that the first boss 20a and the second boss 20b do not protrude downward beyond the oil pump housing 14. Further, the first boss 20a and the second boss 20b are disposed so as to be spaced apart from each other in the Z-axis direction. As a result, a recessed portion 24 is formed between the first boss 20a and the second boss 20b. A first screw hole 21a is formed on a distal end side of the first boss 20a. A second screw hole 21b is formed on a distal end side of the second boss 20b.

The lower housing 6 further includes a third boss 20c and a fourth boss 20d. The third boss 20c and the fourth boss 20d are disposed on an upper side (the Y-axis positive direction side) with respect to the first boss 20a and the second boss 20b. Further, the third boss 20c is provided on the same side as the first boss 20a, and the fourth boss 20d is provided on the same side as the second boss 20b, in the Z-axis direction (a direction in which the balancer shafts 2 and 3 are lined up). In other words, the third boss 20c is disposed at a position closer to the first boss 20a than to the second boss 20b, and the fourth boss 20d is disposed at a position closer to the second boss 20b than to the first boss 20a, in a horizontal direction orthogonal to the axial direction of the balancer shafts 2 and 3. In the present embodiment, the third boss 20c is disposed at the same position as the first boss 20a, and the fourth boss 20d is disposed on the Z-axis negative direction side with respect to the second boss 20b, in the Z-axis direction. A third screw hole 21c is formed on the third boss 20c, and a fourth screw hole 21d is formed on the fourth boss 20d. In the present embodiment, the third boss 20c is formed so as to protrude upward beyond the mating surfaces 5a and 6a of the upper housing 5 and the lower housing 6. As a result, the third screw hole 21c is also formed on an upper side with respect to the mating surfaces 5a and 6a. The screw holes 21a to 21d are disposed at positions corresponding to the bosses 14a of the oil pump housing 14. Therefore, the oil pump 12 is fastened to the lower housing 6 by insertion of the pump fastening bolts 17b in the screw holes of the bosses 14a and the screw holes 21a to 21d from the X-axis negative direction side.

With the oil pump 12 attached to the lower housing 6, the intake portion 18 is disposed at least partially in the recessed portion 24 formed between the first boss 20a and the second boss 20b. In the present embodiment, as illustrated in FIG. 6, half or more of the intake portion 18 is disposed on an upper side with respect to an imaginary line L2 connecting a center of the screw hole 21a and the screw hole 21b in a cross section orthogonal to the X axis (i.e., a cross section in parallel with the YZ plane).

As illustrated in FIG. 2, the first boss 20a is reinforced by a reinforcement rib 22a extending from the lower housing 6. More specifically, the first boss 20a and the bearing support portion 8 are connected to each other via the reinforcement rib 22a extending in the X-axis direction. Although being not illustrated in FIG. 2, the third boss 20c is also reinforced by a reinforcement rib 22b extending from the lower housing 6. Further, the second boss 20b and the fourth boss 20d, and the bearing support portion 8 are connected to each other via a reinforcement rib 23 formed into a generally Y-shape as viewed from the Y-axis direction. The reinforcement rib 23 is provided so as to cover the driven gear chamber (not illustrated) containing therein the driven gear 2c in the balancer housing 4. The drive gear chamber is formed with a thinner thickness than the other portions, and therefore can have improved strength due to this configuration.

In the above-described balancer apparatus 1, when the engine is activated and the crankshaft is rotationally driven, the balancer shaft 2 rotates at the speed twice the crankshaft. The driven shaft 3 rotates in an opposite direction from the drive shaft 2 at the same speed as the drive shaft 2 through transmission of a rotational force due to meshed engagement between the interlocking gears 2a and 3a. By this operation, the balancer weights of the balancer shafts 2 and 3 also rotate in opposite directions from each other, and cancel left and right centrifugal forces of the balancer shafts 2 and 3 themselves. In this manner, both the balancer weights rotate according to the rotations of the balancer shafts 2 and 3 to transmit a vibratory force to the engine, by which a secondary vibration of the engine is prevented or reduced.

According to the above-described balancer apparatus 1, the balancer housing 4 and the oil pump housing 14 are different members. Therefore, the balancer apparatus 1 can be designed highly flexibly. Further, the first boss 20a and the second boss 20b protrude downward, so that a great width can be secured as a width over which the bosses 20a to 20d are arranged in the vertical direction (i.e., a width between the positions at which the oil pump 12 is supported). Therefore, the oil pump 12 can be supported with improved stiffness. In addition, the intake portion 18 of the oil pump 12 is disposed at least partially in the recessed portion 24 formed between the first boss 20a and the second boss 20b, which contributes to preventing or cutting down an increase in a height of the balancer apparatus 1 due to the downward protrusion of the first boss 20a and the second boss 20b. Especially in the present embodiment, half or more of the intake portion 18 is disposed on the upper side with respect to the imaginary line L2 connecting the center of the screw hole 21a of the first boss 20a and the center of the screw hole 21b of the second boss 20b in the cross section orthogonal to the X axis. Therefore, the increase in the height of the balancer apparatus 1 can be effectively prevented or cut down.

Further, according to the balancer apparatus 1, the opening portion 18d of the intake portion 18 is opened toward the opposite side from the first boss 20a and the second boss 20b in the X-axis direction. Therefore, the increase in the height of the balancer apparatus 1 can be prevented or cut down. Further, the balancer apparatus 1 includes the oil strainer 13 extending in the X-axis direction. The oil strainer 13 includes a first end portion connected to the opening portion 18d and a second end portion opened downward (the distal end portion 13a). Therefore, while the increase in the height of the balancer apparatus 1 is prevented or cut down, the intake portion 18 and a desired position in the oil pan covering the lower side of the balancer apparatus 1 can be brought into communication with each other. For example, even when the oil is disproportionally distributed in the oil pan because the vehicle runs on a sloping road, the distal end portion 13a can be placed at a position that ensures the introduction of the oil.

Further, according to the balancer apparatus 1, the third boss 20c is formed so as to protrude upward beyond the mating surfaces 5a and 6a between the upper housing 5 and the lower housing 6. Therefore, a further longer distance can be secured as the distance between the first boss 20a and the third boss 20c without an increase in the height of the balancer apparatus 1. Therefore, the oil pump 12 can be supported with further improved stiffness. Instead of or in addition to the third boss 20c, the fourth boss 20d may be formed so as to protrude upward beyond the mating surfaces 5a and 6a between the upper housing 5 and the lower housing 6.

Further, according to the balancer apparatus 1, the first boss 20a and the third boss 20c are reinforced by the reinforcement ribs 22a and 22b extending from the lower housing 6, respectively. Similarly, the second boss 20b and the fourth boss 20d are reinforced by the reinforcement rib 23 extending from the lower housing 6. Therefore, the oil pump 12 can be supported with further high stiffness. Especially in the present embodiment, the first boss 20a, the second boss 20b, and the fourth boss 20d are connected to the bearing support portion 8 having relatively high stiffness, so that the oil pump 12 can be supported with further enhanced stiffness. Further, the reinforcement rib 23 connects the second boss 20b and the fourth boss 20d, and the bearing support portion 8 to each other, so that the oil pump 12 can be supported with further high stiffness. At least one of the bosses 20a to 20d may be reinforced by a reinforcement rib according to the layout of the bosses 20a to 20d. Further, at least one of the first boss 20a and the second boss 20b and at least one of the third boss 20c and the fourth boss 20d, and the bearing support portion 8 may be connected to each other according to the layout of the bosses 20a to 20d.

Further, according to the balancer apparatus 1, the balancer shafts include the drive shaft 2, to which the rotational force of the crankshaft is transmitted, and the driven shaft 3, which rotates in the opposite direction from the drive shaft 2 by the rotational force transmitted from the drive shaft 2. The drive gear is fixed to the driven shaft, and the driven gear 2c is fixed to the drive shaft 12a of the oil pump 12. Then, the rotational force of the driven shaft 3 is transmitted to the oil pump 12 via the speed reduction mechanism 11. As a result, a dimension of the balancer apparatus 1 in the Y-axis direction can be reduced, and the apparatus can have a compact size. Further, the oil pump 12 can be driven at a relatively low speed, so that pump efficiency is improved, as a result of which fuel efficiency is improved. Further, occurrence of cavitation can also be prevented or reduced. Instead of the rotational force of the driven shaft 3, the rotational force of the drive shaft 2 may be transmitted to the oil pump 12.

### Second Embodiment

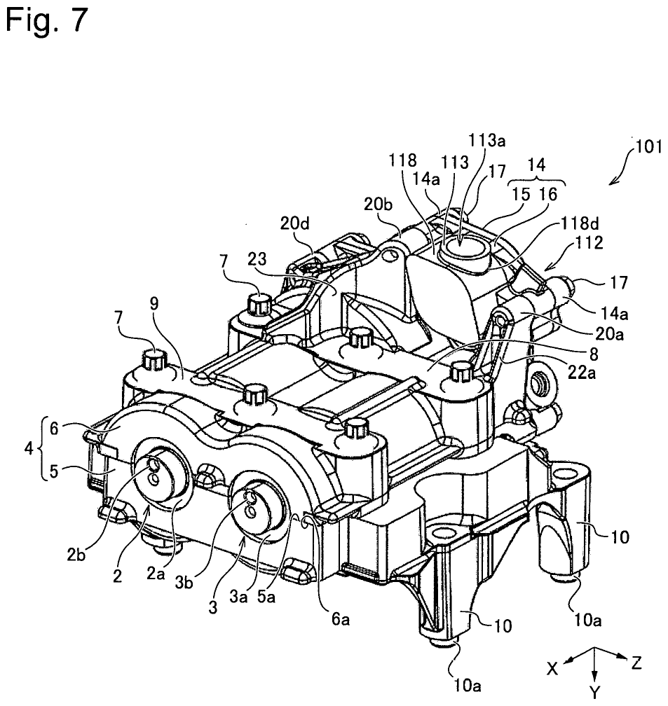

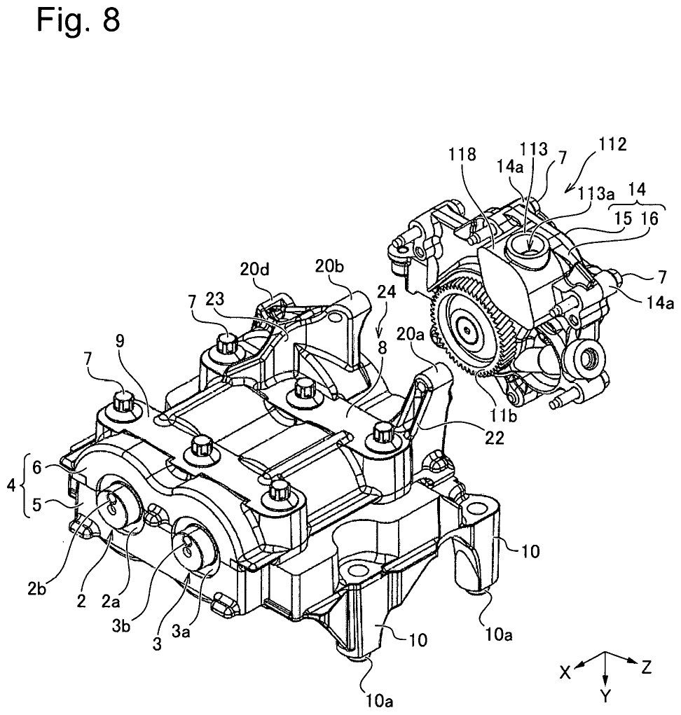

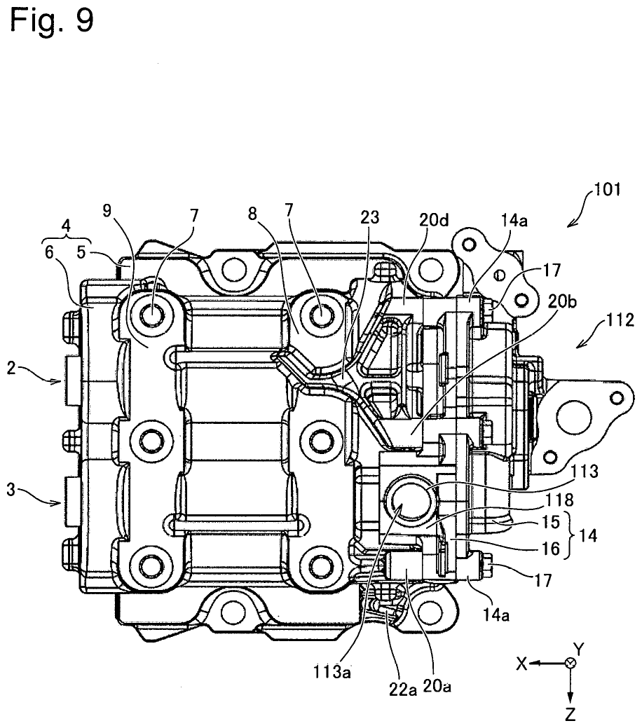

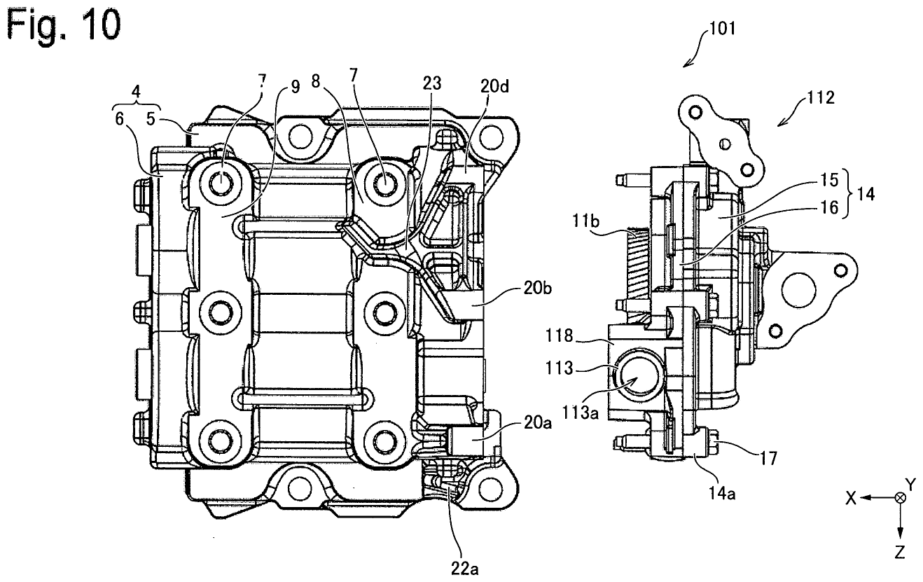

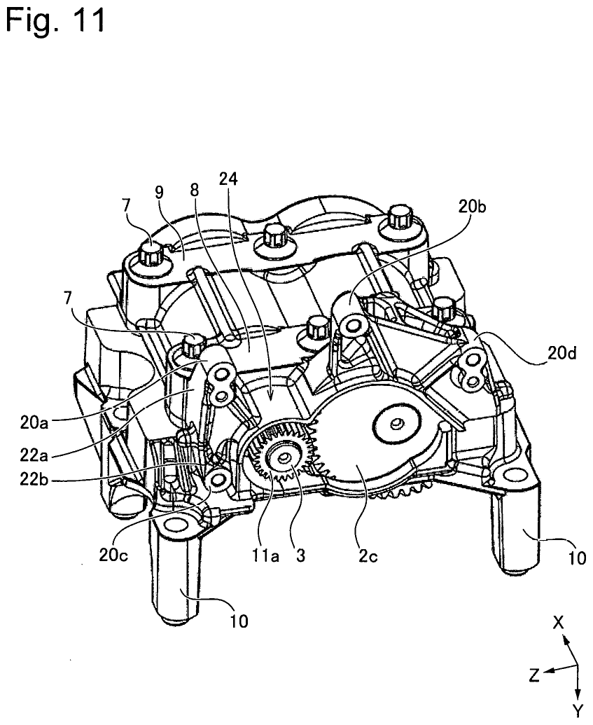

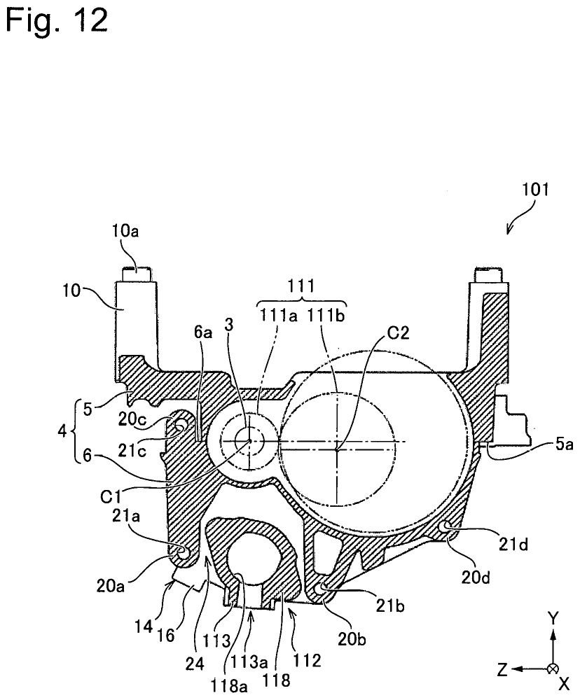

A second embodiment of the present invention will be described. In the following description, similar components to the first embodiment will be identified by the same reference numerals as the first embodiment. Further, components corresponding to the components of the first embodiment will be identified by reference numerals having the same values as the first embodiment in the last two digits. In the following description, the second embodiment will be described, focusing only on differences from the first embodiment. A balancer apparatus 101 according to the second embodiment includes an oil pump 112 instead of the oil pump 12. The balancer apparatus 101 has the same configuration as the balancer apparatus 1 in terms of features that are not especially otherwise specified. FIG. 7 is a perspective view of the balancer apparatus 101 according to the second embodiment. FIG. 8 is a perspective view of the balancer apparatus 101, and illustrates the balancer apparatus 101 with the oil pump 112 removed therefrom. FIG. 9 is a bottom view of the balancer apparatus 101. FIG. 10 is a bottom view of the balancer apparatus 101, and illustrates the balancer apparatus 101 with the oil pump 112 removed therefrom. FIG. 11 is a perspective view of the balancer apparatus 101 according to the second embodiment from which the oil pump 112 is removed. FIG. 12 is a cross-sectional view of the balancer apparatus 101 that corresponds to FIG. 6.

The oil pump 112 includes an intake portion 118. The intake portion 118 includes an opening portion 118d for introducing the oil into the oil pump 112. The opening portion 118d is opened toward the Y-axis negative direction (downward). The intake portion 118 includes a strainer portion 113. The strainer portion 113 linearly extends from the opening portion 118d downward only by a slight distance, and a distal end portion 13a thereof is opened downward. This strainer portion 113 is formed integrally with the intake portion 118. According to this configuration, the number of components can be reduced. Further, the strainer portion 113 allows the oil to be easily introduced.

Further, as illustrated in FIG. 12, a speed reduction mechanism 111 includes a drive gear 111a and a driven gear 111b. The recessed portion 24 formed between the first boss 20a and the second boss 20b is disposed right below the driven shaft 3. Further, a shaft center C1 of the driven shaft 3 is disposed on an upper side with respect to a shaft center C2 of the driven gear 111b. According to this configuration, a depth of the recessed portion 24 can be increased by an amount corresponding to the upward offset of the shaft center C1 of the driven shaft 3 from the shaft center C2 of the driven gear 111b. In other words, the depth of the recessed portion 24 containing the intake portion 118 therein is increased, so that the intake portion 118 can be contained further deeply in the recessed portion 24. Therefore, the increase in the height of the balancer apparatus 101 can be prevented or cut down.

Having described several embodiments of the present invention, the above-described embodiments of the present invention are intended to only facilitate the understanding of the present invention, and are not intended to limit the present invention thereto. Needless to say, the present invention can be modified or improved without departing from the spirit of the present invention, and includes equivalents thereof. Further, the individual components described in the claims and the specification can be arbitrarily combined or omitted within a range that allows them to remain capable of achieving at least a part of the above-described objects or producing at least a part of the above-described advantageous effects. For example, the balancer housing 4 may include a first balancer housing and a second balancer housing formed separately from the first balancer housing and coupled with the first balancer housing, instead of the upper housing 5 and the lower housing 6. In this case, the first balancer housing and the second balancer housing may be divided in the direction orthogonal to the axial directions of the balancer shafts 2 and 3. In other words, the balancer housing may be divided into a front-side balancer housing and a rear-side balancer housing. Further, in another embodiment, the oil pump 12 may be supported at three points or five or more points instead of being supported at the four points by the first bosses 20a to 20d according to the above-described embodiments. For example, the oil pump 12 may be supported at three points by the bosses 20a to 20c.

The present application claims priority to Japanese Patent Application No. 2016-29431 filed on Feb. 19, 2016. The entire disclosure of Japanese Patent Application No. 2016-29431 filed on Feb. 19, 2016 including the specification, the claims, the drawings, and the abstract is incorporated herein by reference in its entirety.

### REFERENCE SIGN LIST

1, 101 balancer apparatus

2 balancer shaft (drive shaft)

2c driven gear

3 balancer shaft (driven shaft)

2a, 3a interlocking gear

2b, 3b reference hole

4 balancer housing

5 balancer housing (upper housing)

6 balancer housing (lower housing)

5a, 6a mating surface

7 housing fastening bolt

8, 9 bearing support portion

10 leg portion

10a hollow pin

11, 111 speed reduction mechanism

11a, 111a drive gear

11b, 111b driven gear

12, 112 oil pump

12a drive shaft

13 oil strainer

13a distal end portion

14 oil pump housing

14a, 14b boss

15 pump body

16 pump cover

17a pump assembling bot

17b pump fastening bolt

18, 118 intake portion

18a intake passage

18b screw hole

18c boss

18d, 118d opening portion

19 strainer fastening bolt

20a first boss

20b second boss

20c third boss

20d fourth boss

21a, 21b, 21c, 21d screw hole

22a, 22b, 23 reinforcement rib

24 recessed portion

113 strainer portion

L1 imaginary line

C1, C2 shaft center

1. A balancer apparatus comprising:
a balancer shaft configured to be rotationally driven;
a balancer housing rotatably containing the balancer shaft therein; and
an oil pump including an oil pump housing formed separately from the balancer housing, the oil pump being attached to the balancer housing,
wherein the balancer housing includes an upper housing and a lower housing formed separately from the upper housing,
wherein the lower housing includes:
a first boss and a second boss configured to fasten the oil pump to the lower housing, and protruding downward on one end side of an axial direction of the balancer shaft; and
a third boss configured to fasten the oil pump to the lower housing, and disposed on an upper side with respect to the first boss and the second boss,
wherein the first boss and the second boss are disposed so as to be spaced apart from each other in a direction orthogonal to the axial direction in such a manner that a recessed portion is formed therebetween,
wherein the oil pump includes an intake portion having an opening portion for introducing oil into the oil pump, and
wherein the intake portion is disposed at least partially in the recessed portion.

2. The balancer apparatus according to claim 1, wherein the lower housing includes a fourth boss configured to fasten the oil pump to the lower housing, and disposed on the upper side with respect to the first boss and the second boss.

3. The balancer apparatus according to claim 1, wherein the first boss includes a first screw hole on a distal end side thereof,
wherein the second boss includes a second screw hole on a distal end side thereof, and
wherein half or more of the intake portion is disposed on an upper side with respect to an imaginary line connecting a center of the first screw hole and a center of the second screw hole in a cross section orthogonal to the axial direction.

4. The balancer apparatus according to claim 1, wherein the opening portion is opened toward an opposite end side in the axial direction.

5. The balancer apparatus according to claim 4, further comprising a strainer extending in the axial direction, and including a first end portion connected to the opening portion and a second end portion opened downward.

6. The balancer apparatus according to claim 1, wherein the opening portion is opened downward.

7. The balancer apparatus according to claim 6, wherein the intake portion includes a strainer portion extending from the opening portion downward, and
wherein the strainer portion is formed integrally with the intake portion.

8. The balancer apparatus according to claim 2, wherein at least one of the third boss and the fourth boss is formed so as to protrude upward beyond mating surfaces between the upper housing and the lower housing.

9. The balancer apparatus according to claim 2, wherein at least one of the first to fourth bosses is reinforced by a reinforcement rib extending from the lower housing.

10. The balancer apparatus according to claim 9, wherein the lower housing includes a bearing support portion partially containing therein a bearing configured to rotatably support the balancer shaft, and
wherein the reinforcement rib is connected to the bearing support portion.

11. The balancer apparatus according to claim 10, wherein the reinforcement rib connects at least one of the first boss and the second boss and at least one of the third boss and the fourth boss, and the bearing support portion to each other.

12. The balancer apparatus according to claim 1, wherein the balancer shaft includes a drive shaft to which a rotational force of a crankshaft of an engine is transmitted, and a driven shaft configured to rotate in an opposite direction from the drive shaft by a rotational force transmitted from the drive shaft, and
wherein the rotational force is transmitted to the oil pump by the drive shaft or the driven shaft.

13. A balancer apparatus comprising:
a balancer shaft configured to be rotationally driven;
a balancer housing rotatably containing the balancer shaft therein, and including a first balancer housing and a second balancer housing formed separately from the first balancer housing and coupled with the first balancer housing; and
an oil pump including an oil pump housing formed separately from the balancer housing, the oil pump being attached to the first balancer housing,
wherein the balancer housing includes:
a first boss and a second boss configured to fasten the oil pump to the first balancer housing, and protruding downward on one end side of an axial direction of the balancer shaft; and
a third boss configured to fasten the oil pump to the first balancer housing, and disposed on an upper side with respect to the first boss and the second boss,
wherein the first boss and the second boss are disposed so as to be spaced apart from each other in a direction orthogonal to the axial direction in such a manner that a recessed portion is formed therebetween,
wherein the oil pump includes an intake portion having an opening portion for introducing oil into the oil pump, and
wherein the intake portion is disposed at least partially in the recessed portion.

14. The balancer apparatus according to claim 13, wherein the first boss includes a first screw hole on a distal end side thereof,
wherein the second boss includes a second screw hole on a distal end side thereof, and
wherein half or more of the intake portion is disposed on an upper side with respect to an imaginary line connecting a center of the first screw hole and a center of the second screw hole in a cross section orthogonal to the axial direction.

15. The balancer apparatus according to claim 13, wherein the balancer apparatus includes a speed reduction mechanism,
wherein the oil pump is a variable displacement oil pump capable of varying a discharge volume thereof, and
wherein a rotational force of the balancer shaft is transmitted to the oil pump via the speed reduction mechanism.

16. The balancer apparatus according to claim 15, wherein the balancer shaft includes a drive shaft to which a rotational force of a crankshaft of an engine is transmitted, and a driven shaft configured to rotate in an opposite direction from the drive shaft by a rotational force transmitted from the drive shaft,
wherein the speed reduction mechanism includes a drive gear and a driven gear having a larger number of teeth than the drive gear,
wherein the drive gear is fixed to the driven shaft, and
wherein the driven gear is fixed to a drive shaft of the oil pump.

17. The balancer apparatus according to claim 16, wherein the recessed portion is disposed right below the driven shaft, and
wherein a shaft center of the driven shaft is disposed on an upper side with respect to a shaft center of the driven gear.
